(19) United States
(12) Patent Application Publication
(10) Pub. No.: US 2026/0246783 A1
(43) Pub. Date: Aug. 20, 2026

(54) MANAGEMENT SYSTEM OF STORAGE SYSTEM AND MANAGEMENT METHOD OF STORAGE SYSTEM

(71) Applicant: Hitachi Vantara, Ltd., Kanagawa-ken (JP)

(72) Inventors: Arisa HATOKO, Yokohama-shi (JP); Tomohiro SHINOHARA, Yokohama-shi (JP); Kotaro YOKOYAMA, Yokohama-shi (JP)

(21) Appl. No.: 19/305,401

(22) Filed: Aug. 20, 2025

(30) Foreign Application Priority Data
Feb. 20, 2025 (JP) 2025-025660

(51) Int. Cl. H04L 9/40

(52) U.S. Cl. CPC H04L 63/105; H04L 63/083; H04L 63/104

(57) ABSTRACT

A management terminal of a management system of a storage system having a multi-tenant configuration includes a plurality of tenant namespaces corresponding to a plurality of tenants and applied to user identification information for identifying the user. An external server corresponding to each tenant has information for authentication for authenticating a user defined by a tenant namespace of the corresponding tenant, and an authentication unit performs authentication of the user by using the external server.

### CROSS-REFERENCE TO RELATED APPLICATIONS

This application claims benefit of priority from JP 2025-025660, filed Feb. 20, 2025, the contents of which are incorporated herein by reference.

### BACKGROUND OF THE INVENTION

### 1. Field of the Invention

The present disclosure relates to a management system of a storage system and a management method of a storage system.

### 2. Description of the Related Art

In recent years, in a large-scale storage aggregation environment, a physical storage device is shared and used by a plurality of companies, a plurality of departments, and the like. In the large-scale storage aggregation environment, resources of one storage can be distributed or shared among a plurality of tenants (companies and departments) by a multi-tenant storage system.

The multi-tenant storage system constructs a virtual storage system by managing a large number of real storage devices by software and defining the entire storage system as a large storage device, and provides virtual storage resources obtained by logically dividing the storage system for each tenant (see WO 2014/184893 A).

In the multi-tenant storage system, in order to reduce a burden of management of the entire storage system, multi-tenancy type management is performed in which storage resources are allocated for each tenant (for each company or department), a storage resource manager is defined, and the allocated storage resources are individually managed.

In the multi-tenant storage system, a security mechanism such as not accidentally destroying a volume of another tenant, not leaking data to another tenant, and not affecting an operation of another storage resource administrator is required.

JP 2024-102743 A discloses a multi-tenant management system that enables a user to access resources of a plurality of tenants without authentication for each namespace while ensuring independence between tenants. The multi-tenant management system selects a namespace corresponding to the user from a plurality of namespaces, and determines whether the user is a valid user by using user management information of the namespace. In a case where the result of the determination is true, the system determines whether or not the resource of the access destination according to the resource access request from the user belongs to the resource access range corresponding to any one of the tenant scopes (the label of the resource access range of each tenant) indicated by the user management information of the selected namespace based on the overall scope management information (information in which the tenant scope and the resource access range are associated) common to all tenants. In a case where a result of the determination is true, the system causes the resource access request to be executed.

Patent References: Japanese patent application JP 2024-102743 A

### SUMMARY OF THE INVENTION

In the multi-tenancy type management, a role (authority) is given to a storage resource administrator in units of user groups, a storage resource (a set of storage resources) that can be managed by the role is allocated to the user group as a resource group, and the authority to enable an operation such as a user management operation or a storage resource management operation on the storage resource (the set of storage resources) allocated to the user group to which the storage resource administrator belongs is given to the storage resource administrator. In addition, in the multi-tenancy type management, an authority to enable use of storage resources (a set of storage resources) allocated to the user group to which the storage user belongs is given to the storage user. Hereinafter, the storage resource administrator and the storage user are called “user” in a case where it is not particularly necessary to distinguish them.

In the multi-tenancy type management, the management of the storage resource for each tenant is realized by authenticating the user on the authentication base of the storage system, authorizing the group to which the authenticated user belongs, giving the authorized user the authority to the storage resource allocated to the authorized group, and enabling the storage resource to be operated and used within the scope of the authority.

The multi-tenancy type management includes a soft multi-tenant management method and a hard multi-tenant management method. The hard multi-tenant management method is required to have stricter requirements such as security than the soft multi-tenant management method.

While the soft multi-tenant management method manages users in units of all tenants, the hard multi-tenant management method is required to manage users independently in each tenant (manage information related to authentication and authorization of a user including a user ID) from the viewpoint of preventing data leakage to other tenants, security, and the like.

The soft multi-tenant management method is applied to, for example, a case where users belonging to each tenant belong to the same common organization and there is no problem even if the users are managed in units of all tenants (for example, a case where a storage system of a company asset is shared by a plurality of departments in the company). The hard multi-tenant management method is applied to, for example, a case where a user belonging to each tenant belongs to a separate organization, and it is necessary to manage the user independently in each tenant from the viewpoint of preventing data leakage to other tenants, security, and the like (for example, a case where a storage system is shared by a plurality of arbitrary organizations on a public cloud).

An example of a conventional multi-tenant storage system may employ a configuration in which a common namespace is used by all tenants, and a user ID or the like for identifying a user is managed (paragraphs [0092] to [0095] and FIG. 8 of JP 2024-102743 A). However, when this configuration is adopted, a user ID having the same name cannot be assigned to different tenants. Therefore, since it is necessary to use a user ID having different name for all tenants, usability is deteriorated as the number of tenants increases.

On the other hand, another example of a conventional multi-tenant storage system may employ a configuration in which an independent namespace is used for each tenant, and a user ID or the like for identifying a user is managed (paragraphs [0096] to [0126] and FIG. 9 of JP 2024-102743 A). In the other example of a conventional multi-tenant storage system, a namespace selection unit selects a namespace allocated to a tenant based on tenant information acquired from a tenant acquisition unit of a user terminal, and performs user authentication by using a user management table allocated to the selected namespace.

The conventional multi-tenant storage system can adopt a configuration that performs user authentication using an external system (an external server) from the viewpoint of improving security, reducing costs, and the like. For example, paragraph [0074] of JP 2024-102743 A describes that it is also possible to entrust the authentication process to an external authentication system.

However, in a case where the conventional multi-tenant storage system adopts a configuration for performing user authentication using an external system (an external server) and then applies a hard multi-tenant management method, an external server used for authentication and authorization is not prepared independently for each tenant. Therefore, the storage system cannot cope with independent user management (management of information regarding authentication and authorization of a user including a user ID) for each tenant required by the hard multi-tenant management method. In addition, in a case where an external server used for authentication and authorization is prepared independently for each tenant, it is necessary to have a configuration in which a user authentication request requested from each tenant to the storage system is processed by an independent external server corresponding to each tenant. However, this configuration is not described in JP 2024-102743 A. In addition, even in a case of adopting a configuration in which user authentication is performed using an external system (an external server), it is required to improve usability by enabling allocation of a user ID having the same name to different tenants.

The present disclosure has been made in view of the above problems. That is, an object of the present disclosure is to provide a management system of a storage system and a management method of a storage system capable of improving usability while handling independent user management for each tenant.

In order to solve the above problem, a management system of a storage system of the present disclosure is a management system of a storage system having a multi-tenant configuration including an authentication unit which provides a storage resource to a plurality of tenants, authenticates a user, and grants role information defining an operation authority of the storage resource to the user, the management system including: an external server for authentication corresponding to each of the plurality of tenants, wherein the authentication unit includes a plurality of tenant namespaces corresponding to a plurality of the tenants and applied to user identification information for identifying the user, each of the external servers has information for authentication for authenticating the user defined by the tenant namespace of the corresponding tenant, and the authentication unit receives authentication information including the user identification information from a host belonging to the tenant, and executes authentication of the user using the external server corresponding to the tenant.

A management method of a storage system according to the present disclosure is a management method of a storage system having a multi-tenant configuration including an authentication unit which provides a storage resource to a plurality of tenants, authenticates a user, and grants role information defining an operation authority of the storage resource to the user, the management method including: using an external server for authentication corresponding to each of a plurality of the tenants; wherein the authentication unit includes a plurality of tenant namespaces corresponding to a plurality of the tenants and applied to user identification information for identifying the user, each of the external servers has information for authentication for authenticating the user defined by the tenant namespace of the corresponding tenant, and the authentication unit receives authentication information including the user identification information from a host belonging to the tenant, and executes authentication of the user using the external server corresponding to the tenant.

According to the present disclosure, usability can be improved while handling independent user management for each tenant. Note that the effects described herein are not necessarily limited, and may be any of the effects described in the present disclosure.

### BRIEF DESCRIPTION OF THE DRAWINGS

FIG. 1 is a diagram illustrating a system configuration example of a management system of a storage system according to an embodiment of the present disclosure;

FIG. 2 is a diagram illustrating a hardware configuration example of a storage system;

FIG. 3 is a diagram for describing a multi-tenant function of a storage system;

FIG. 4 is a diagram illustrating a hardware configuration example of a storage node;

FIG. 5 is a diagram illustrating a hardware configuration example of a computer applied to a management terminal;

FIG. 6 is a functional block diagram of an authentication base;

FIG. 7 is a functional block diagram of an external server for a system administrator, an external server for a tenant A, an external server for a tenant B, and an external server for a tenant C;

FIG. 8A is a diagram for describing an authentication base management table;

FIG. 8B is a diagram for describing a management table for a system administrator;

FIG. 9 is a diagram for describing a management table for a tenant A;

FIG. 10 is a diagram for describing a management table for a tenant B;

FIG. 11 is a diagram for describing a management table for a tenant C;

FIG. 12 is a diagram for describing an authentication and authorization information table for a system administrator stored in an external server for a system administrator;

FIG. 13 is a diagram for describing an authentication and authorization information table for a tenant A stored in an external server for a tenant A;

FIG. 14 is a diagram for describing an authentication and authorization information table for a tenant B stored in an external server for a tenant B;

FIG. 15 is a diagram for describing an authentication and authorization information table for a tenant C stored in an external server for a tenant C;

FIG. 16 is a diagram for describing a configuration information DB management table;

FIG. 17 is a sequence diagram for explaining an operation of a system;

FIG. 18 is a flowchart for describing processing executed by an authentication and authorization execution unit of an authentication base;

FIG. 19 is a diagram illustrating a system configuration example of a modification of a management system of a storage system; and

FIG. 20 is a diagram illustrating a system configuration example of a modification of a management system of a storage system.

### DESCRIPTION OF THE PREFERRED EMBODIMENTS

Preferred embodiments of the present invention will be described below with reference to the accompanying drawings. Note that like reference numerals may refer to like parts throughout.

In the following description, various types of information may be described with expressions such as “table”, “record”, “row”, “column”, and “line”, but the various types of information may be expressed with a data structure other than these expressions. When identification information is described, expressions such as “ID” and “name” are used, but these expressions can be replaced with each other, and can also be replaced with expressions of other identification information.

In the following description, processing may be described with a functional block as a subject, but the subject of the processing may be a processor or a device (a management terminal or an external server) instead of the functional block.

### Embodiment

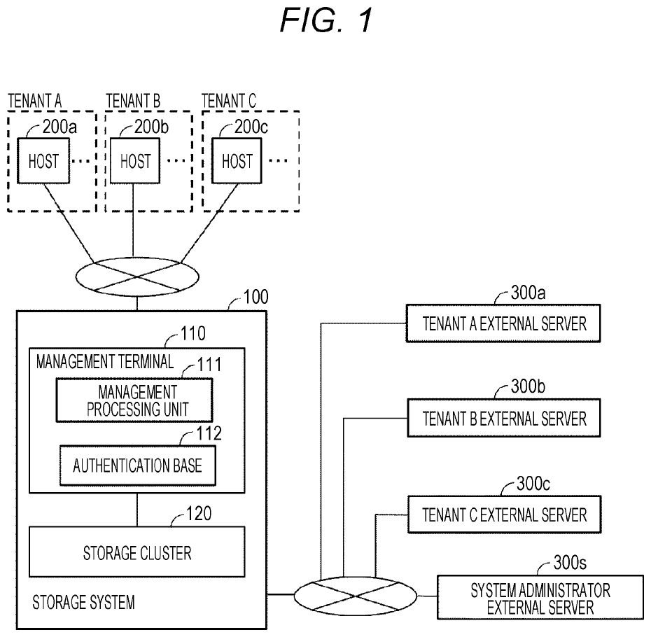

FIG. 1 is a diagram illustrating a configuration example of a management system of a storage system according to an embodiment of the present disclosure.

The management system includes a storage system 100, a host 200a belonging to a tenant A such as a customer, a host 200b belonging to a tenant B such as a customer, a host 200c belonging to a tenant C such as a customer, a system administrator external server 300s, a tenant A external server 300a, a tenant B external server 300b, and a tenant C external server 300c. Note that, hereinafter, the host 200a to the host 200c may be referred to as “host 200” in a case where it is not necessary to particularly distinguish them. The system administrator external server 300s, the tenant A external server 300a, the tenant B external server 300b, and the tenant C external server 300c may be referred to as “external server 300” in a case where it is not necessary to particularly distinguish them. The management system may not include the host 200.

The host 200 and the storage system 100 are communicably connected to each other via a network. The storage system 100 and the external server 300 are communicably connected to each other via a network.

The storage system 100 includes a management terminal 110 and a storage cluster 120. The management terminal 110 is a computer for managing and operating the entire storage system 100. The management terminal 110 includes a management processing unit 111 and an authentication base 112. The authentication base may be referred to as an “authentication unit”. Note that details of these functions will be described later.

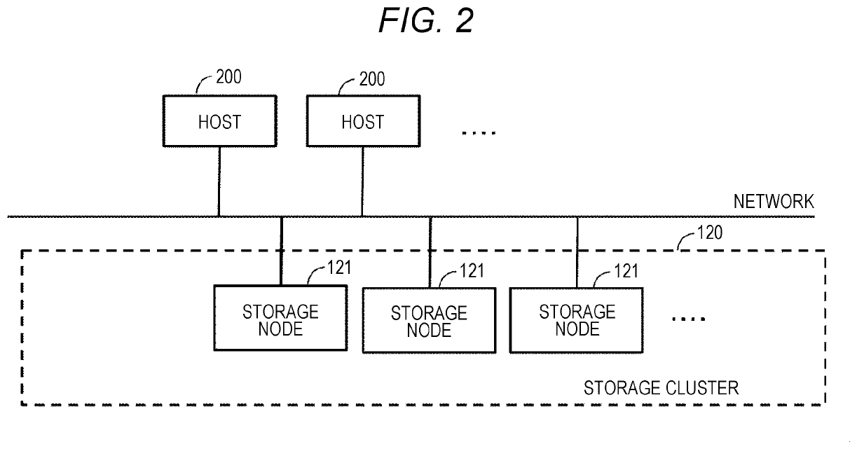

As illustrated in FIG. 2, the storage cluster 120 is a virtual storage system including a plurality of storage nodes 121. The storage system 100 has a multi-tenant function (multi-tenant configuration).

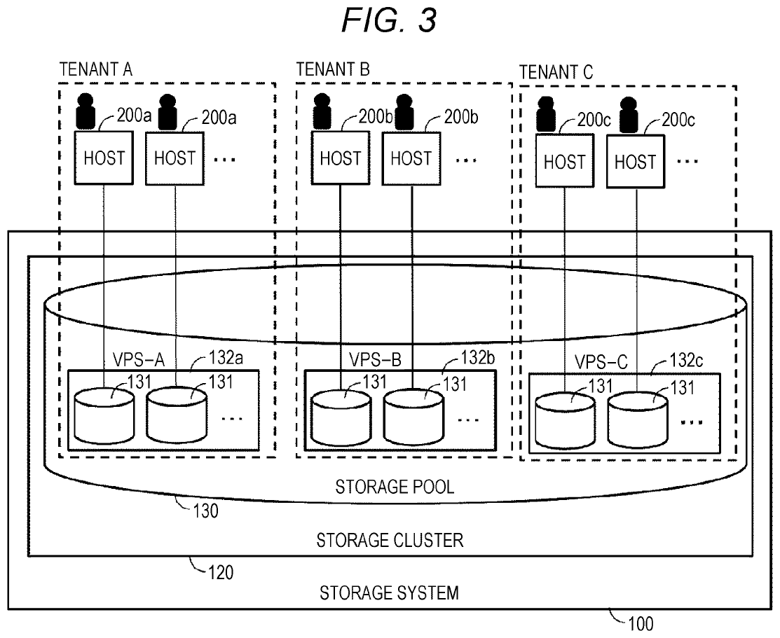

FIG. 3 is a diagram for describing a multi-tenant function (multi-tenant configuration) of the storage system 100. In FIG. 3, the management terminal 110 is not illustrated. As illustrated in FIG. 3, the storage cluster 120 included in the storage system 100 includes a storage pool 130. The multi-tenant function is a function of allowing the storage pool 130, which is a storage resource, to be distributed or shared by a plurality of tenants in the storage system 100.

The storage pool 130 is a logical user data storage in which a plurality of drives included in the plurality of storage nodes 121 are collected. From the storage pool 130, a plurality of volumes 131 can be created within a range in which the total capacity is equal to or less than the capacity of the storage pool 130. The volumes 131 that have been created are connected to the host 200 of each tenant. The host 200 can read and write data relative to the volumes 131 that have been connected.

Each distributed storage system is a virtual private storage (VPS) which is a storage resource provided to each tenant. In this example, a VPS132a is provided (allocated) to the tenant A, a VPS132b is provided (allocated) to the tenant B, and a VPS132c is provided (allocated) to the tenant C. The VPS132a, the VPS132b, and the VPS132c may be referred to as a VPS132 in a case where it is not necessary to distinguish them.

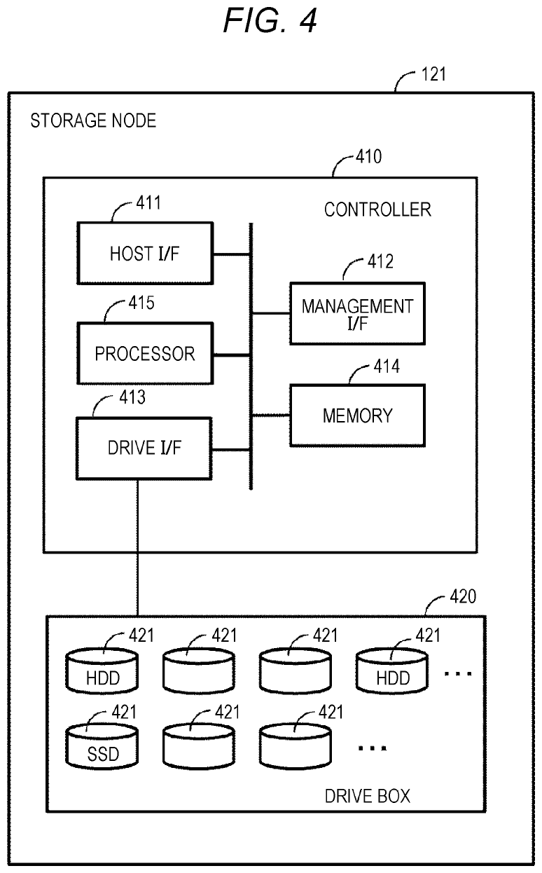

FIG. 4 is a diagram illustrating a hardware configuration example of the storage node 121. As illustrated in FIG. 4, the storage node 121 includes a controller 410 and a drive box 420. The controller 410 includes a host interface 411, a management interface 412, a drive interface 413, a memory 414, and a processor 415 connected thereto. Note that the number of these components is arbitrary.

The host interface 411 is an interface device for communication with the host 200. The management interface 412 is an interface device for communication with the management terminal 110. The drive interface 413 is an interface device for communication with the drive box 420.

The drive box 420 accommodates a plurality of drives 421, which are nonvolatile storage devices capable of reading and writing one or more data storing various data. The drive box 420 is connected to the drive interface 413 of the controller 410. The drive 421 is, for example, a hard disk drive (HDD), a solid state drive (SSD) 139, or the like.

The processor 415 is a control device that controls the operation of the entire storage node 121, and executes various processes by executing various programs stored in the memory 414. The memory 414 stores, for example, control information used by the storage node 121, a program executed by the processor 415, data accessed by the host 200, various tables, and the like. The memory 414 is generally formed with a dynamic random access memory (RAM) (DRAM), but may be formed with a storage medium other than the DRAM, for example, a magneto-resistive RAM (MRAM), a resistive RAM (ReRAM), a phase change memory (PCM), a NAND, or the like.

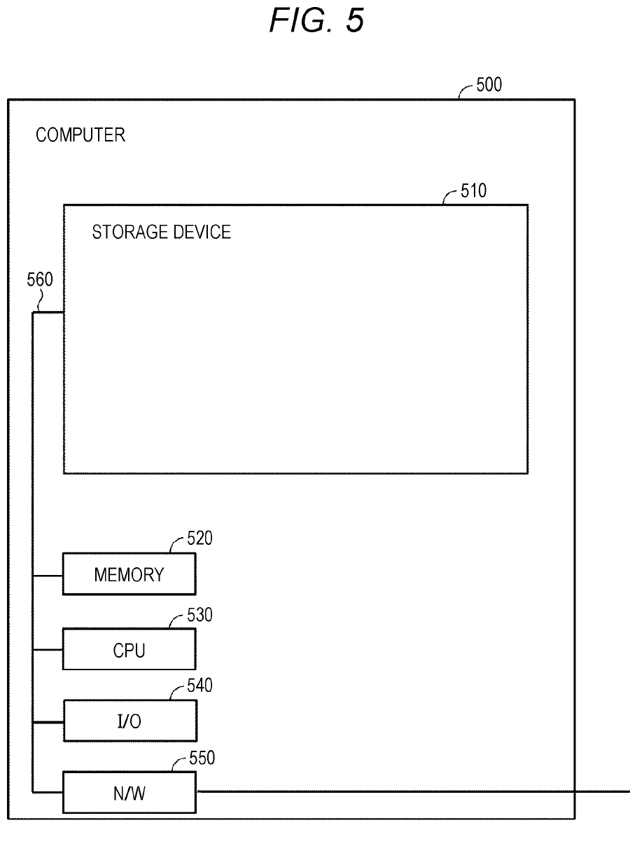

FIG. 5 is a diagram illustrating a hardware configuration example of the computer 500 applied to the management terminal 110. As illustrated in FIG. 5, the computer 500 includes a nonvolatile storage device 510 capable of reading and writing data, a memory 520 (for example, RAM), a CPU530 as a processor, an input/output interface 540, a network interface 550, and a bus 560. The computer may be a virtual computer built on a cloud.

The storage device 510 stores various programs, various data, and the like. The CPU530 loads the program stored in the storage device 510 into the memory 520. The CPU530 implements various functions by executing the program loaded in the memory 520.

As described above, the program executed by the CPU530 is loaded into the memory 520, and data used when the CPU530 executes the program is temporarily stored.

The input/output interface 540 is an interface for connecting operation devices such as a keyboard and a mouse, a display, and the like. The network interface 550 is an interface for connecting the computer 500 to a network.

The external server 300 includes the computer 500 illustrated in FIG. 5. The external server 300 may be a virtual computer built on a cloud, or may include a plurality of computers.

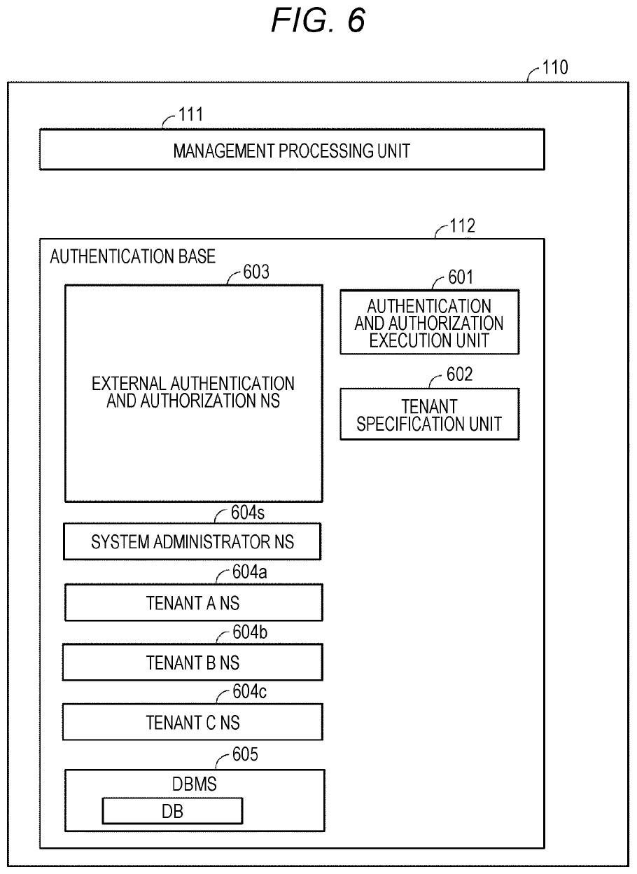

FIG. 6 is a functional block diagram for explaining details of functions of the management terminal 110. As described above, the management terminal 110 includes the management processing unit 111 and the authentication base 112. The management processing unit 111 and the authentication base 112 correspond to a program and/or data stored in the storage device 510 of the computer 500 applied to the management terminal 110.

The management processing unit 111 provides an interface for the storage system 100 to communicate with the host 200. The host 200 can perform, by the management processing unit 111, operations such as acquisition, storage, update, and deletion of data through an API provided by the storage system 100. The management processing unit 111 receives a request from the host 200, performs appropriate processing according to the request, and then returns a response to the host 200. For example, in response to a data acquisition request from the host 200, designated data is returned.

The authentication base 112 includes an authentication and authorization execution unit 601, a tenant specification unit 602, an external authentication and authorization namespace 603, a system administrator namespace 604s, a tenant A namespace 604a, a tenant B namespace 604b, a tenant C namespace 604c, and a database management system (DBMS) 605.

Every time the management processing unit 111 receives a request of a user from the host 200, the authentication and authorization execution unit 601 receives the request from the management processing unit 111, acquires information necessary for authentication and authorization included in the request, and executes authentication and authorization of the user using the external server 300. The tenant specification unit 602 specifies a tenant to which the host 200 that is the transmission source of the request belongs.

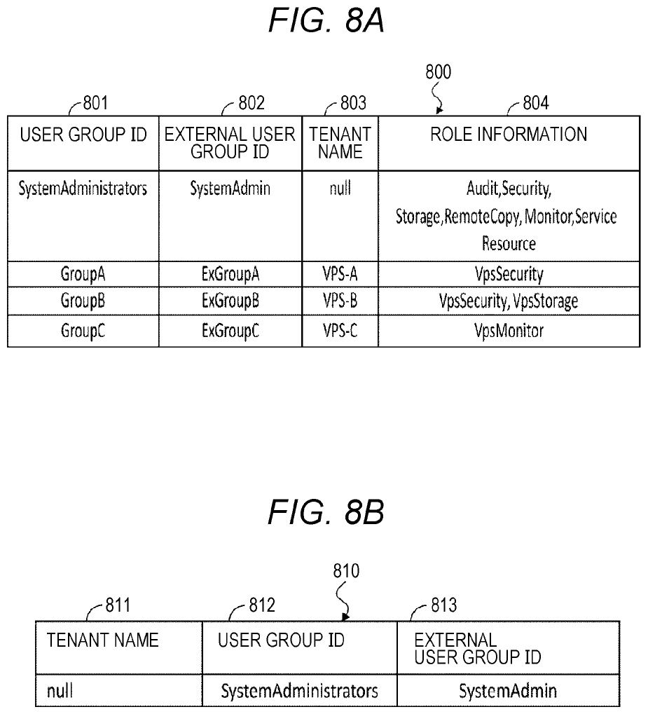

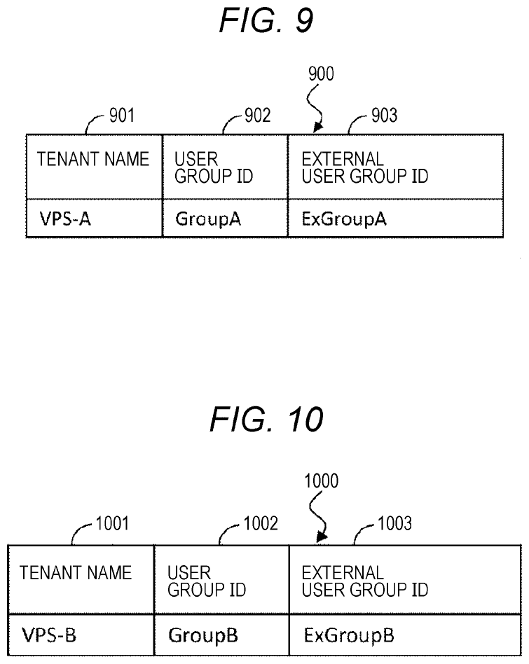

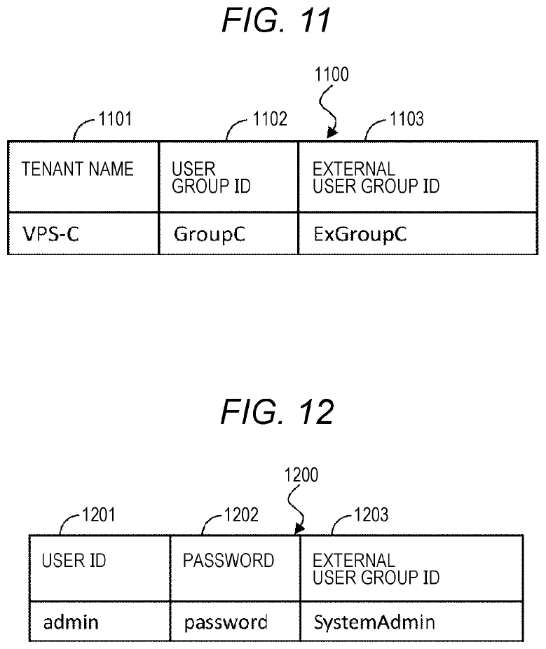

The external authentication and authorization namespace 603 includes an authentication base management table 800 (see FIG. 8A). The system administrator namespace 604s includes a system administrator management table 810 (see FIG. 8B). The tenant A namespace 604a includes a tenant A management table 900 (see FIG. 9). The tenant B namespace 604b includes a tenant B management table 1000 (see FIG. 10). The tenant C namespace 604c includes a tenant C management table 1100 (see FIG. 11). The storage system 100 employs a configuration in which an independent namespace is used in each tenant to manage a user ID and the like for identifying a user.

The DBMS605 is software for managing a database (DB), and includes tools and functions for creating, managing, and operating the database. The DBMS605 manages and operates a database (DB) created and held (saved, stored). The DBMS605 is, for example, PostgreSQL.

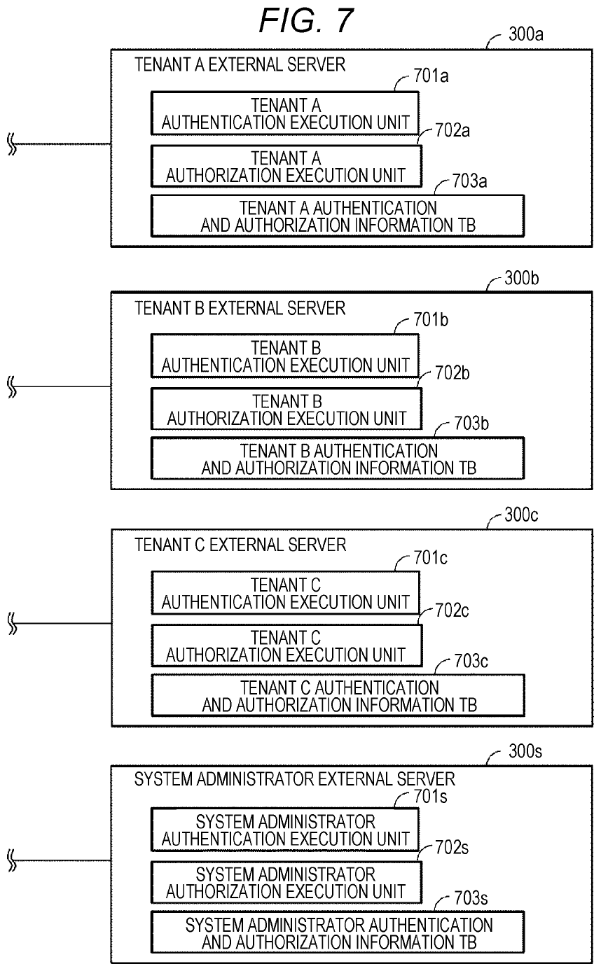

FIG. 7 is a functional block diagram of the system administrator external server 300s, the tenant A external server 300a, the tenant B external server 300b, and the tenant C external server 300c.

As illustrated in FIG. 7, the system administrator external server 300s includes a system administrator authentication execution unit 701s, a system administrator authorization execution unit 702s, and a system administrator authentication and authorization information table 703s (see FIG. 12).

The system administrator authentication execution unit 701s and the system administrator authorization execution unit 702s correspond to a program stored in the storage device 510 of the computer 500 applied to the system administrator external server 300s. The system administrator authentication and authorization information table 703s corresponds to data stored in the storage device 510 of the computer 500 applied to the system administrator external server 300s.

The system administrator authentication execution unit 701s executes authentication of the system administrator in response to a request from the authentication base 112, and returns an authentication result to the authentication base 112. In a case where the authentication of the system administrator is successful, the system administrator authorization execution unit 702s assigns (authorizes) an external user group ID to the system administrator and returns the external user group ID to the authentication base 112. The external user group ID may be referred to as “specification information” for specifying the role. The system administrator authentication and authorization information table 703s is information (information for authentication) used for authentication of the system administrator. Note that the system administrator authentication and authorization information table 703s will be described later in detail with reference to FIG. 12.

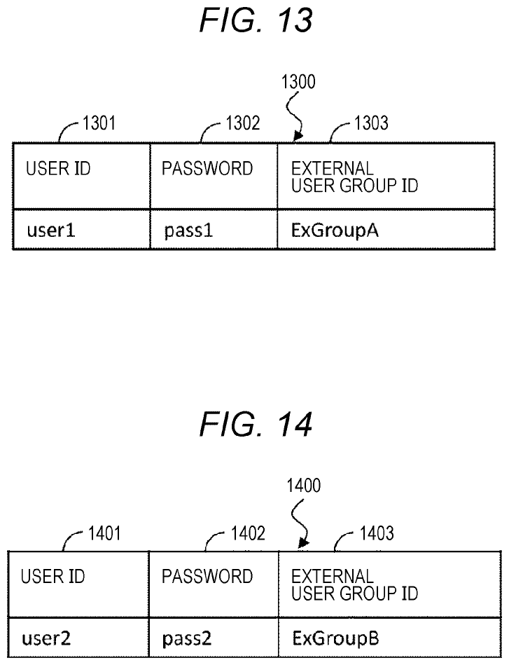

The tenant A external server 300a includes a tenant A authentication execution unit 701a, a tenant A authorization execution unit 702a, and a tenant A authentication and authorization information table 703a (see FIG. 13).

The tenant A authentication execution unit 701a and the tenant A authorization execution unit 702a correspond to the program stored in the storage device 510 of the computer 500 applied to the tenant A external server 300a. The tenant A authentication and authorization information table 703a corresponds to data stored in the storage device 510 of the computer 500 applied to the tenant A external server 300a.

The tenant A authentication execution unit 701a executes authentication of the user belonging to the tenant A in response to a request from the authentication base 112, and returns an authentication result to the authentication base 112. In a case where the authentication of the system administrator is successful, the tenant A authorization execution unit 702a assigns (authorizes) the external user group ID to the system administrator and returns the external user group ID to the authentication base 112. The tenant A authentication and authorization information table 703a is information (information for authentication) created using the namespace for the tenant A and used for authentication of the user belonging to the tenant A. The tenant A authentication and authorization information table 703a will be described later in detail with reference to FIG. 13.

The tenant B external server 300b includes a tenant B authentication execution unit 701b, a tenant B authorization execution unit 702b, and a tenant B authentication and authorization information table 703b (see FIG. 14). The tenant B authentication execution unit 701b executes authentication of the user belonging to the tenant B in response to a request from the authentication base 112, and returns an authentication result to the authentication base 112.

The tenant B authentication execution unit 701b and the tenant B authorization execution unit 702b correspond to the program stored in the storage device 510 of the computer 500 applied to the tenant B external server 300b. The tenant B authentication and authorization information table 703b corresponds to data stored in the storage device 510 of the computer 500 applied to the tenant B external server 300b.

In a case where the authentication of the system administrator is successful, the tenant B authorization execution unit 702b assigns (authorizes) the external user group ID to the system administrator and returns the external user group ID to the authentication base 112. The tenant B authentication and authorization information table 703b is information (information for authentication) created using the namespace for the tenant B and used for authentication of the user belonging to the tenant B. The tenant B authentication and authorization information table 703b will be described later in detail with reference to FIG. 14.

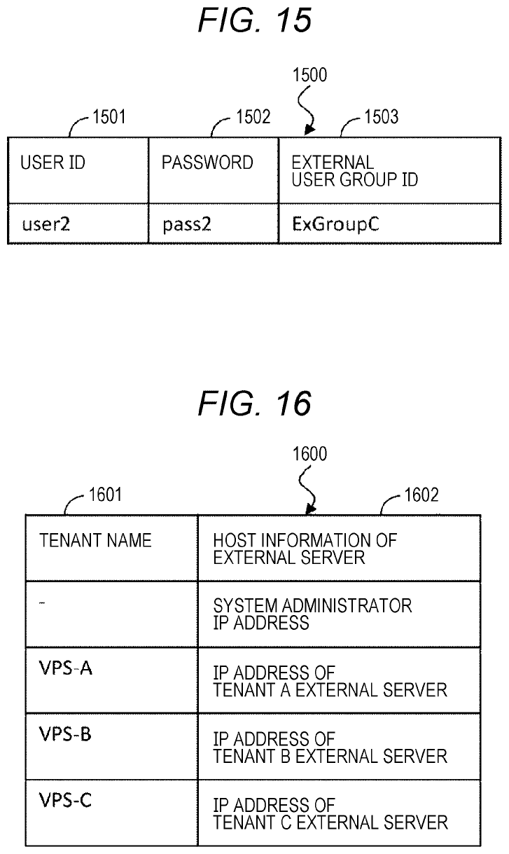

The tenant C external server 300c includes a tenant C authentication execution unit 701c, a tenant C authorization execution unit 702c, and a tenant C authentication and authorization information table 703c (see FIG. 15).

The tenant C authentication execution unit 701c and the tenant C authorization execution unit 702c correspond to the program stored in the storage device 510 of the computer 500 applied to the tenant C external server 300c. The tenant C authentication and authorization information table 703c corresponds to data stored in the storage device 510 of the computer 500 applied to the tenant C external server 300c.

The tenant C authentication execution unit 701c executes authentication of the user belonging to the tenant C in response to a request from the authentication base 112, and returns an authentication result to the authentication base 112. In a case where the authentication of the system administrator is successful, the tenant C authorization execution unit 702c assigns (authorizes) the external user group ID to the system administrator and returns the external user group ID to the authentication base 112. The tenant C authentication and authorization information table 703c is information (information for authentication) created using the namespace for the tenant C and used for authentication of the user belonging to the tenant C. The tenant C authentication and authorization information table 703c will be described later in detail with reference to FIG. 15.

The management system of the present disclosure includes the external servers 300 for authentication and authorization corresponding to each of a plurality of tenants, and each external server 300 has authentication and authorization information (the tenant A authentication and authorization information table 703a, the tenant B authentication and authorization information table 703b, and the tenant C authentication and authorization information table 703c) for authenticating and authorizing a user defined by a tenant namespace of a corresponding tenant.

The management system of the present disclosure can support the independent user management for each tenant required by the hard multi-tenant management method in the case of applying the hard multi-tenant management method after adopting the configuration in which the external server 300 used for the authentication and authorization is independently prepared for each tenant and the user authentication and authorization is performed using the external server 300.

In addition, the management system of the present disclosure uses an independent namespace for each tenant to manage the user ID and the like, and thus, even in a case where a configuration is adopted in which user authentication is performed using the external server 300, user IDs having the same name can be assigned between different tenants, and thus, usability can be improved.

FIG. 8A is a diagram for describing the authentication base management table 800. As illustrated in FIG. 8A, the authentication base management table 800 includes a user group ID801, an external user group ID802, a tenant name 803, and role information 804 as columns that store information (values). In the authentication base management table 800, information corresponding to each column related to user management is stored as information (record) in units of rows in association with each other.

Specifically, the user group ID801 stores an ID for identifying a user group. The user group is obtained by grouping user accounts. Access to a management target can be controlled by associating the external user group, the VPS132, and the role with the user group. The external user group ID802 stores an ID for identifying an external user group. The external user group is obtained by grouping user accounts, and is a group corresponding to the user group. The tenant name 803 stores the name of the VPS132 allocated to the tenant operable by the user. The VPS132 is associated with a user group, and the VPS132 that can be operated by the user is determined according to a user group which a user belongs to. Note that, in a case where the name of the specific VPS132 is not stored in the tenant name 803 (in a case of “null”), there is no limitation on the VPS that can be operated, and it means that all the VPS can be operated. Note that the name of the VPS132 also functions as identification information for identifying a tenant, and thus may be also referred to as “tenant identification information”.

The role information 804 stores role information (referred to as a “role” in some cases). The role is to define an item (authority) that the user can operate with respect to the storage system 100. A role is associated with a user group (an ID indicating a user group), and an item (authority) that can be operated by the user is determined according to a user group which the user belongs to.

The role is specifically described as described below. “Audit” indicates an administrator of the entire audit log, and indicates that an operation defined for the role (for example, all VPS can be audited, for example) can be executed. “Security” indicates an administrator of overall security, and indicates that an operation defined for the role can be executed. “Storage” indicates an administrator of the storage in general, and indicates that an operation defined for the role can be executed. “RemoteCopy” indicates an administrator of remote copy in general, and indicates that an operation defined for the role can be executed. “Monitor” indicates a monitoring person of the overall storage, and indicates that an operation defined for the role (for example, as an administrator, referring to the volume in the VPS to detect a volume failure) can be executed. “Service” indicates a maintenance administrator of the overall storage, and indicates that an operation defined for the role can be executed. “Resource” indicates an administrator who allocates a resource to the VPS, and indicates that an operation defined for the role (for example, reference, creation, editing, and deletion of VPS) can be executed.

“VpsSecurity” indicates a security administrator of the VPS, and indicates that an operation defined for the role (for example, an operation related to user management in the VPS which the user is in charge of, and an operation for managing a user, a user group, and a session which are necessary as a security administrator) can be executed. “VpsStorage” indicates a storage administrator of the VPS, and indicates that an operation defined for the role (an operation for managing resources required as a storage administrator) can be executed. “VpsMonitor” indicates a monitoring person of the VPS, and indicates that an operation defined for the role (referring to the following resources in the VPS which the monitoring person is in charge of) can be executed.

FIG. 8B is a diagram for describing the system administrator management table 810. As illustrated in FIG. 8B, the system administrator management table 810 includes a tenant name 811, a user group ID812, and an external user group ID813 as columns that store information (values). In the system management table 810, information corresponding to each column related to management of the system administrator is stored as information (record) in units of rows in association with each other.

Specifically, the tenant name 811 is “null” meaning that no information is stored. The user group ID812 stores an ID (a user group ID) for identifying a user group. The external user group ID903 stores an ID (an external user group ID) for identifying an external user group.

FIG. 9 is a diagram for describing the tenant A management table 900. As illustrated in FIG. 9, the tenant A management table 900 includes a tenant name 901, a user group ID902, and an external user group ID903 as columns that store information (values). In the tenant A management table 900, information corresponding to each column related to the management of the user belonging to the tenant A is stored as information (record) in units of rows in association with each other.

Specifically, the tenant name 901 stores the name of the VPS132 allocated to the tenant. The user group ID902 stores an ID (a user group ID) for identifying a user group. The external user group ID903 stores an ID (an external user group ID) for identifying an external user group.

FIG. 10 is a diagram for describing the tenant B management table 1000. As illustrated in FIG. 10, the tenant B management table 1000 includes a tenant name 1001, a user group ID1002, and an external user group ID1003 as columns that store information (values). In the tenant B management table 1000, information corresponding to each column related to the management of the user belonging to the tenant B is stored as information (record) in units of rows in association with each other.

Specifically, the tenant name 1001 stores the name of the VPS132 allocated to the tenant. The user group ID1002 stores an ID (a user group ID) for identifying a user group. The external user group ID1003 stores an ID (an external user group ID) for identifying an external user group.

FIG. 11 is a diagram for describing the tenant C management table 1100. As illustrated in FIG. 11, the tenant C management table 1100 includes a tenant name 1101, a user group ID1102, and an external user group ID1103 as columns that store information (values). In the tenant C management table 1100, information corresponding to each column related to the user belonging to the tenant C is stored as information (record) in units of rows in association with each other.

Specifically, the tenant name 1101 stores the name of the VPS132 allocated to the tenant. The user group ID1102 stores an ID (a user group ID) for identifying a user group. The external user group ID1103 stores an ID (an external user group ID) for identifying an external user group.

FIG. 12 is a diagram for describing a system administrator authentication and authorization information table 1200 stored by the system administrator external server 300s. As illustrated in FIG. 12, the system administrator authentication and authorization information table 1200 includes a user ID1201, a password 1202, and an external user group ID1203 as columns in which information (values) is stored. In the system administrator authentication and authorization information table 1200, information corresponding to each column regarding information used for authentication of the system administrator is stored as information (record) in units of rows in association with each other.

Specifically, the user ID1201 stores an ID for identifying the user. The password 1202 stores a password. The external user group ID1203 stores an ID (an external user group ID) for identifying an external user group.

FIG. 13 is a diagram for describing a tenant A authentication and authorization information table 1300 stored by the tenant A external server 300a. As illustrated in FIG. 13, the tenant A authentication and authorization information table 1300 includes a user ID1301, a password 1302, and an external user group ID1303 as columns in which information (values) is stored. In the tenant A authentication and authorization information table 1300, information corresponding to each column regarding information to be used for authentication of the user belonging to the tenant A is stored as information (record) in units of rows in association with each other.

Specifically, the user ID1301 stores an ID for identifying the user. The password 1302 stores a password. The external user group ID1303 stores an ID (an external user group ID) for identifying an external user group.

FIG. 14 is a diagram for describing a tenant B authentication and authorization information table 1400 stored by the tenant B external server 300b. As illustrated in FIG. 14, the tenant B authentication and authorization information table 1400 includes a user ID1401, a password 1402, and an external user group ID1403 as columns in which information (values) is stored. In the tenant B authentication and authorization information table 1400, information corresponding to each column regarding information to be used for authentication of the user belonging to the tenant B is stored as information (record) in units of rows in association with each other.

Specifically, the user ID1401 stores an ID for identifying the user. The password 1402 stores a password. The external user group ID1403 stores an ID (an external user group ID) for identifying an external user group.

FIG. 15 is a diagram for describing a tenant C authentication and authorization information table 1500 stored by the tenant C external server 300c. As illustrated in FIG. 15, the tenant C authentication and authorization information table 1500 includes a user ID1501, a password 1502, and an external user group ID1503 as columns in which information (values) is stored. In the tenant C authentication and authorization information table 1500, information corresponding to each column regarding information to be used for authentication of the user belonging to the tenant C is stored as information (record) in units of rows in association with each other.

Specifically, the user ID1501 stores an ID for identifying the user. The password 1502 stores a password. The external user group ID1503 stores an ID (an external user group ID) for identifying an external user group.

FIG. 16 is a diagram for describing the configuration information DB management table 1600. As illustrated in FIG. 16, the configuration information DB management table 1600 includes a tenant name 1601 and host information 1602 of the external server 300 as columns in which information (values) is stored. In the configuration information DB management table 1600, information corresponding to each column regarding management of the tenant and the external server 300 is stored as information (record) in units of rows in association with each other. Specifically, the tenant name 1601 stores a name for identifying the VPS132 allocated to the tenant. The host information 1602 of the external server 300 stores the IP address of the external server 300.

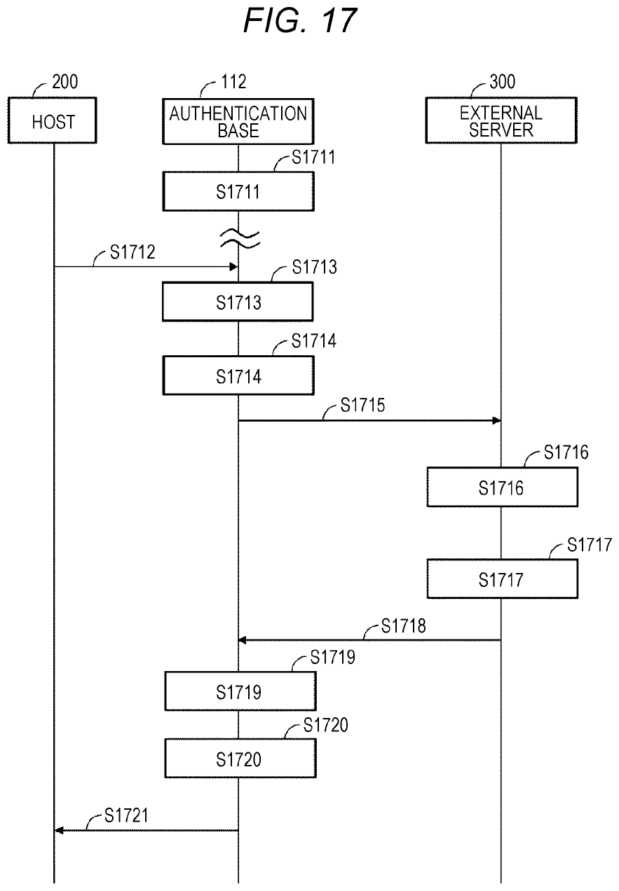

FIG. 17 is a sequence diagram for describing an operation of the system.
S1711: The authentication base 112 names (sets (registers))a host name of a transmission destination of a request for a tenant using tenant identification information at a certain timing. The certain timing is, for example, a timing at which a user creates a tenant namespace. The user uses tenant identification information for identifying a tenant to which the user belongs, and creates a fully qualified domain name (FQDN) including the tenant identification information as a host name of a request transmission destination. For example, when the tenant identification information is VPS-A that is a name of the VPS132a, the FQDN is “VPS-A.sds-block.hitachi.com”.
S1712: The host 200 transmits a user request including a user ID and a password as authentication information and a request for performing an operation such as acquisition, storage, update, or deletion of data with respect to the storage system 100 to the management processing unit 111 (not shown in FIG. 17) based on the operation of the user. The authentication base 112 receives the user request via the management processing unit 111 (not shown in FIG. 17).

Note that the request is created by software included in the host 200 so as to include an FQDN including tenant identification information for identifying the tenant to which the user belongs as the host name of the request transmission destination. For example, in a case where the request transmitted from the host 200 used by the user belonging to the tenant A is the GET method, “https://VPS-A.sds-block.hitachi.com/ConfigurationManager/s imple/v1/objects/volumes” is created. In the GET method, the tenant identification information “VPS-A” is included in the FQDN as the host name of the transmission destination of the request.
S1713: In the authentication base 112, the tenant specification unit 602 extracts the tenant identification information included as the host name from the FQDN included in the request, and specifies a tenant to which the user belongs based on the extracted tenant identification information.
S1714: The authentication base 112 refers to the configuration information DB management table 1600 of FIG. 16 included in the database managed by the DBMS605 using the tenant identification information extracted in S1713 and acquires host information (IP address) of the external server 300 by the authentication and authorization execution unit 601.
S1715: The authentication base 112 transmits, by the authentication and authorization execution unit 601, the user ID, the password, and the authentication and authorization request to the external server 300 (hereinafter, referred to as a “corresponding external server 300” in some cases) specified in S1714.
S1716: In a case of receiving the user ID, the password, and the authentication and authorization request from the authentication base 112, the corresponding external server 300 collates the received user ID and password with corresponding information (authentication and authorization information table) in the corresponding external server 300 to perform authentication. In a case where the received user ID and password exist in the authentication and authorization information table and are associated with each other, the authentication succeeds.
S1717: In a case where the authentication succeeds, the corresponding external server 300 specifies (allocates to the user (authorizes)) an ID indicating the corresponding external user group from the user ID and the password in the authentication and authorization information table.
S1718: The corresponding external server 300 transmits the specified external user group ID and a result of successful authentication to the authentication base 112.
S1719: The authentication base 112 specifies the user group ID and the tenant identification information to be used in the storage cluster 120 from the external user group ID based on the tenant management table (a table corresponding to the tenant specified in S1713 among the tenant A management table 900 to the tenant C management table 1100 (the system administrator table 810 when no tenant is specified)) by the authentication and authorization execution unit 601. Specifically, the authentication base 112 specifies the user group ID and the tenant identification information associated with the external user group ID in the tenant management table by the authentication and authorization execution unit 601. Note that, in a case where the user is a system administrator, only the user group ID is specified.
S1720: The authentication base 112 allocates the role (note that, in a case where the user is a system administrator, the role corresponding to the user group ID) corresponding to the user group ID and the tenant identification information to the user who has operated the host 200 that has transmitted the request based on the authentication base management table 800 by the authentication and authorization execution unit 601 (authorizes the role to the user).
S1721: The authentication base 112 transmits, by the authentication and authorization execution unit 601, an authentication and authorization result to the host 200.

The above is the operation of the management system. In the management system of the present disclosure, the external server 300 used for authentication and authorization is prepared independently for each tenant. In this case, it is difficult for the authentication base 112 to specify the external server 300 corresponding to the tenant as the transmission source of the authentication information and to specify the external server 300 requesting the authentication and authorization. On the other hand, in the present system, the FQDN including the tenant identification information as the host name of the transmission destination of the request is created and set using the tenant identification information.

In the authentication base 112, the tenant specification unit 602 extracts the tenant identification information included as the host name of the transmission destination of the request from the FQDN included in the request, and the authentication and authorization execution unit 601 specifies the host information of the external server 300 based on the extracted tenant identification information. As a result, the management system of the present disclosure can specify the external server 300 that requests the authentication and authorization, and request the appropriate external server 300 corresponding to each tenant for the authentication and authorization.

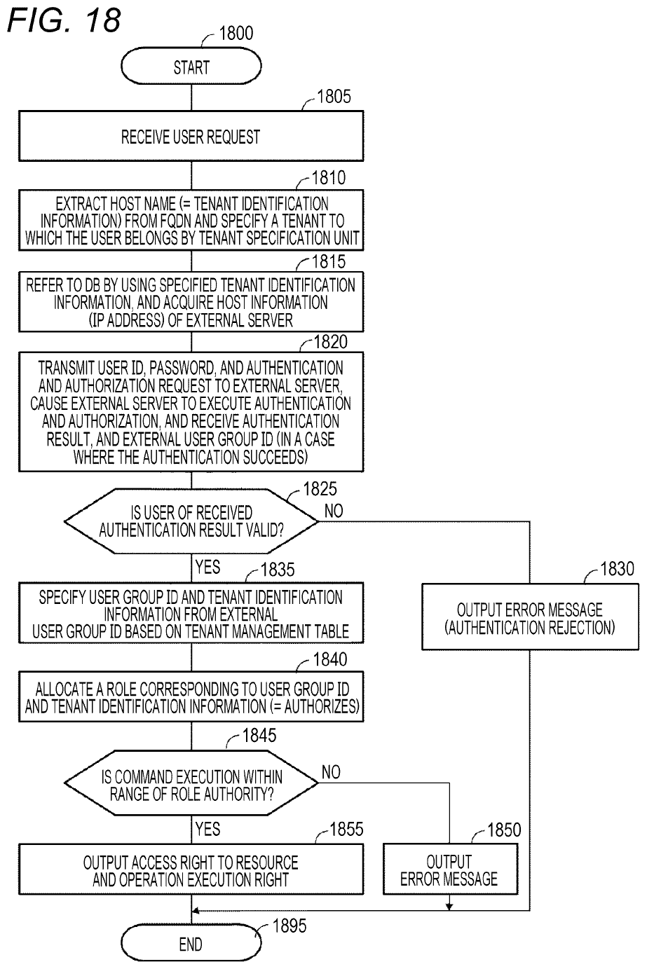

FIG. 18 is a flowchart for describing processing executed by the authentication and authorization execution unit 601 of the authentication base 112.

The authentication and authorization execution unit 601 starts the processing from step 1800, sequentially executes processing of steps 1805 to 1820 described below, and then proceeds to step 1825.
Step 1805: The authentication and authorization execution unit 601 receives a user request from the host 200 via the management processing unit 111.
Step 1810: As described above, the authentication and authorization execution unit 601 extracts the tenant identification information included as the host name from the FQDN included in the request, and specifies a tenant to which the user belongs based on the extracted tenant identification information by the tenant specification unit 602.
Step 1815: As described above, the authentication and authorization execution unit 601 refers to the configuration information DB management table 1600 in FIG. 16 included in the database by using the specified tenant identification information, and acquires the host information (IP address) of the external server 300.
Step 1820: The authentication and authorization execution unit 601 transmits the user ID, the password, and the authentication and authorization request to the external server 300 indicated by the specified IP address, causes the external server 300 to execute user authentication, and receives an authentication result. In a case where the authentication succeeds, the authentication and authorization execution unit 601 also receives the external user group ID.

Proceeding to step 1825, the authentication and authorization execution unit 601 determines whether the user of the authentication result received from the external server 300 is valid (that is, whether or not the authentication result indicates successful authentication).

In a case where the user of the authentication result is not valid (in a case where the authentication fails), the authentication and authorization execution unit 601 determines “NO” in step 1825, proceeds to step 1830, and outputs an error message indicating authentication rejection to the host 200 via the management processing unit 111. Thereafter, the authentication and authorization execution unit 601 proceeds to step 1895 and temporarily ends the present processing flow.

In a case where the user of the authentication result is valid (in a case where the authentication succeeds), the authentication and authorization execution unit 601 determines “YES” in step 1825, sequentially executes processing of step 1835 and step 1840 described below, and then, proceeds to step 1845.
Step 1835: The authentication and authorization execution unit 601 specifies the user group ID and the tenant identification information from the external user group ID based on the tenant management table (the table corresponding to the tenant specified in step 1810 among the tenant A management table 900 to the tenant C management table 1100).
Step 1840: The authentication and authorization execution unit 601 allocates a role (note that, in a case where the user is a system administrator, the role corresponding to the user group ID) corresponding to the user group ID and the tenant identification information specified based on the authentication base management table 800 to the user (that is, authorizes).

In a case where the processing proceeds to step 1845, the authentication and authorization execution unit 601 determines whether the command execution is within the range of the role authority. That is, it is determined whether or not the user has a role necessary for the operation requested by the request.

In a case where the command execution is not within the range of the role authority, the authentication and authorization execution unit 601 determines “NO” in step 1845, proceeds to step 1850, and outputs an error message to the host 200 via the management processing unit 111. Thereafter, the authentication and authorization execution unit 601 proceeds to step 1895 and temporarily ends this processing flow.

In a case where the command execution is within the range of the role authority, the authentication and authorization execution unit 601 determines “YES” in step 1845, proceeds to step 1855, and outputs the access right to the operation target resource and the operation execution right to the management processing unit 111. As a result, access to the resource to be operated by the request is permitted, and operation to the resource to be operated is permitted. Thereafter, the authentication and authorization execution unit 601 proceeds to step 1895 and temporarily ends this processing flow.

### Effects

As described above, the management system of the storage system 100 according to the embodiment of the present disclosure can improve usability while handling independent user management for each tenant.

### Modifications

The present disclosure is not limited to the above embodiment, and various modifications can be adopted within the scope of the present disclosure. Furthermore, the above-described embodiments can be combined with each other without departing from the scope of the present disclosure.

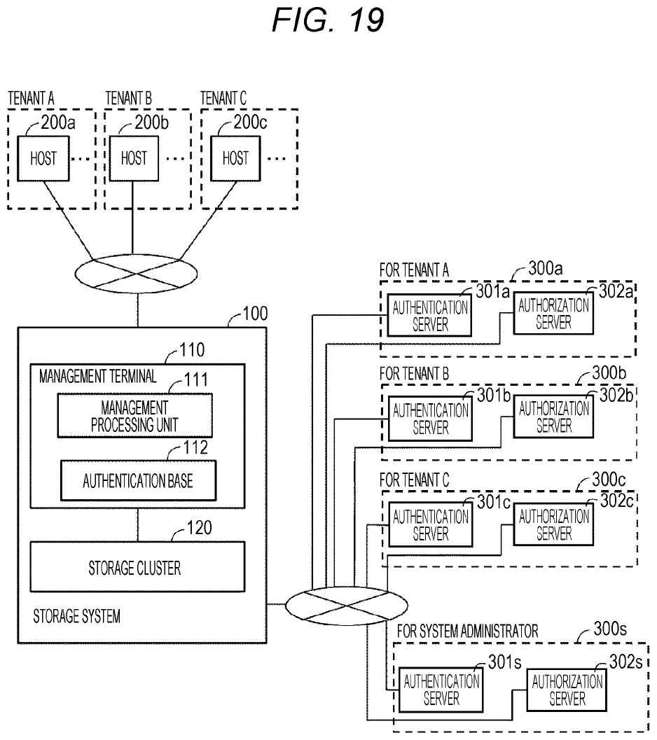

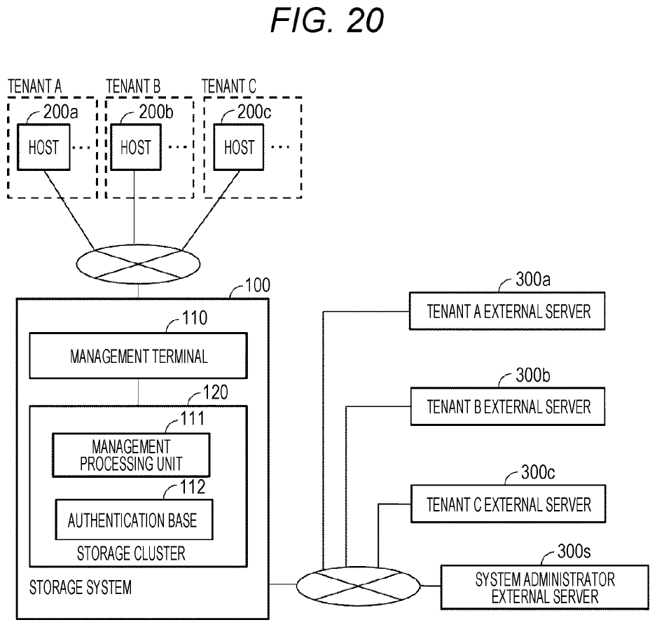

In the above embodiment, as illustrated in FIG. 19, the system administrator external server 300s may include a system administrator authentication server 301s and a system administrator authorization server 302s. The tenant A external server 300a may include the tenant A authentication server 301a and the tenant A authorization server 302a. The tenant B external server 300b may include the tenant B authentication server 301b and the tenant B authorization server 302b. The tenant C external server 300c may include the tenant C authentication server 301c and the tenant C authorization server 302c.

In this case, the system administrator authentication server 301s includes a system administrator authentication execution unit 701s and a system administrator authentication and authorization information table 703s. The system administrator authorization server 302s includes a system administrator authorization execution unit 702s and a system administrator authentication and authorization information table 703s. The tenant A authentication server 301a includes a tenant A authentication execution unit 701a and a tenant A authentication and authorization information table 703a. The tenant A authorization server 302a includes a tenant A authorization execution unit 702a and a tenant A authentication and authorization information table 703a.

The tenant B authentication server 301b includes a tenant B authentication execution unit 701b and a tenant B authentication and authorization information table 703b. The tenant B authorization server 302b includes a tenant B authorization execution unit 702b and a tenant B authentication and authorization information table 703b. The tenant C authentication server 301c includes a tenant C authentication execution unit 701c and a tenant C authentication and authorization information table 703c. The tenant C authorization server 302c includes a tenant C authorization execution unit 702c and a tenant C authentication and authorization information table 703c.

In the above embodiment, as illustrated in FIG. 20, the management processing unit 111 and the authentication base 112 may be included in the storage cluster 120 instead of the management terminal 110. Note that, also in the modification illustrated in FIG. 19, the management processing unit 111 and the authentication base 112 may be included in the storage cluster 120 instead of the management terminal 110.

The present disclosure can also have the following configurations.

A management system of a storage system having a multi-tenant configuration including an authentication unit which provides a storage resource to a plurality of tenants, authenticates a user, and grants role information defining an operation authority of the storage resource to the user, the management system including:
an external server for authentication corresponding to each of the plurality of tenants,
wherein the authentication unit includes a plurality of tenant namespaces corresponding to a plurality of the tenants and applied to user identification information for identifying the user,
each of the external servers has information for authentication for authenticating the user defined by the tenant namespace of the corresponding tenant, and
the authentication unit receives authentication information including the user identification information from a host belonging to the tenant, and executes authentication of the user using the external server corresponding to the tenant.

A management method of a storage system having a multi-tenant configuration including an authentication unit which provides a storage resource to a plurality of tenants, authenticates a user, and grants role information defining an operation authority of the storage resource to the user, the management method including:
using an external server for authentication corresponding to each of a plurality of the tenants;
wherein the authentication unit includes a plurality of tenant namespaces corresponding to a plurality of the tenants and applied to user identification information for identifying the user,
each of the external servers has information for authentication for authenticating the user defined by the tenant namespace of the corresponding tenant, and
the authentication unit receives authentication information including the user identification information from a host belonging to the tenant, and executes authentication of the user using the external server corresponding to the tenant.

What is claimed is:

1. A management system of a storage system having a multi-tenant configuration including an authentication unit which provides a storage resource to a plurality of tenants, authenticates a user, and grants role information defining an operation authority of the storage resource to the user, the management system comprising:
an external server for authentication corresponding to each of the plurality of tenants, wherein
the authentication unit includes a plurality of tenant namespaces corresponding to a plurality of the tenants and applied to user identification information for identifying the user,
each of the external servers has information for authentication for authenticating the user defined by the tenant namespace of the corresponding tenant, and
the authentication unit receives authentication information including the user identification information from a host belonging to the tenant, and executes authentication of the user using the external server corresponding to the tenant.

2. The management system of the storage system according to claim 1, wherein
the authentication unit executes authorization to specify a user group to which the user belongs by using the external server corresponding to the tenant.

3. The management system of the storage system according to claim 2, wherein
the authentication unit specifies the external server corresponding to the tenant of a transmission source of the authentication information, transmits the authentication information to the specified external server, causes the external server to execute authentication and the authorization of the user based on the authentication information and the information for authentication, receives specification information for specifying the role information including an authentication result from the external server, specifies the role information based on the specification information, and allocates the specified role information to the user.

4. The management system of the storage system according to claim 3, wherein
the authentication unit receives, from the host, a request that includes the authentication information and tenant identification information for identifying the tenant and requests an operation on the storage resource, and
the authentication unit extracts the tenant identification information from the request, and specifies the external server corresponding to the tenant based on the tenant identification information.

5. The management system of the storage system according to claim 4, wherein
the authentication unit includes information in which the tenant identification information and host information of the external server are associated with each other, and specifies the external server corresponding to the tenant by specifying the host information based on the information and the tenant identification information that has been extracted.

6. The management system of the storage system according to claim 4, wherein
the information for authentication includes information in which the user identification information and external user group identification information for identifying the user group are associated with each other, and
the external server specifies the external user group identification information based on the user identification information of the user that has been authenticated based on the information for authentication, and transmits the external user group identification information that has been specified to the authentication unit as the specification information.

7. The management system of the storage system according to claim 6, wherein
the authentication unit includes tenant management information,
the tenant management information is defined by the tenant namespace, and is information in which the tenant identification information, user group identification information for identifying the user group, and the external user group identification information are associated with each other, and
the authentication unit specifies the tenant identification information and the user group identification information based on the external user group identification information specified by the external server based on the tenant management information.

8. The management system of the storage system according to claim 7, wherein
the authentication unit is a namespace different from a plurality of the tenant namespaces, and includes an external authentication and authorization namespace applied to the user group identification information, the tenant identification information, and the role information, and authentication base management information defined by the external authentication and authorization namespace,
the authentication base management information is information in which the tenant identification information, the user group identification information, and the role information are associated with each other, and
the authentication unit specifies the role information based on the tenant identification information and the user group identification information based on the authentication base management information.

9. The management system of the storage system according to claim 1, wherein
the external server authenticates the user based on the authentication information and the information for authentication.

10. The management system of the storage system according to claim 9, wherein
the authentication information includes the user identification information and a password.

11. A management method of a storage system having a multi-tenant configuration including an authentication unit which provides a storage resource to a plurality of tenants, authenticates a user, and grants role information defining an operation authority of the storage resource to the user, the management method comprising:
using an external server for authentication corresponding to each of a plurality of the tenants, wherein
the authentication unit includes a plurality of tenant namespaces corresponding to a plurality of the tenants and applied to user identification information for identifying the user,
each of the external servers has information for authentication for authenticating the user defined by the tenant namespace of the corresponding tenant, and
the authentication unit receives authentication information including the user identification information from a host belonging to the tenant, and executes authentication of the user using the external server corresponding to the tenant.
